(19) United States
(12) Patent Application Publication
(10) Pub. No.: US 2015/0089934 A1
(43) Pub. Date: Apr. 2, 2015

(54) DUAL OPERATION HYDRAULIC CONTROL

(71) Applicant: FORD GLOBAL TECHNOLOGIES, LLC, DEARBORN, MI (US)

(72) Inventors: Adam J. Richards, Canton, MI (US); Lev Pekarsky, W. Bloomfield, MI (US); Robert Orley Burkhart, Novi, MI (US); Mark Davis, Plymouth, MI (US)

(73) Assignee: FORD GLOBAL TECHNOLOGIES, LLC, DEARBORN, MI (US)

(21) Appl. No.: 14/039,282

(22) Filed: Sep. 27, 2013

(51) Int. Cl. F15B 15/20

(52) U.S. Cl. CPC F15B 15/20
USPC 60/393

(57) ABSTRACT

A pressurized fluid storage system is suitable for use to rapidly engage a transmission following an engine shutdown. The system includes a reservoir, such as an accumulator, connected to a manifold by a single passageway. A pump provides pressurized fluid to the manifold while a transmission control system draws fluid from the manifold. A check valve in the single passageway passively holds fluid in the reservoir when pressure in the reservoir exceeds pressure in the manifold and allows flow into the reservoir when the manifold pressure is higher. An actively controlled actuator overrides the passive check ball to release pressurized fluid into the manifold to rapidly re-engage transmission clutches.

### TECHNICAL FIELD

This disclosure relates to the field of hydraulic controls for a vehicle powertrain. More particularly, the disclosure pertains to a system to store and release pressurized fluid.

### BACKGROUND

Many vehicles are used over a wide range of vehicle speeds, including both forward and reverse movement as well as stationary periods. Internal combustion engines, however, are capable of operating efficiently only within a narrow range of speeds. Consequently, transmissions capable of efficiently transmitting power at a variety of speed ratios are frequently employed. When the vehicle is at low speed, the transmission is usually operated at a high speed ratio such that it multiplies the engine torque for improved acceleration. At high vehicle speed, operating the transmission at a low speed ratio permits an engine speed associated with quiet, fuel efficient cruising. The most common type of automatic transmission has a set of clutches and brakes. The various speed ratios are selected by supplying pressurized hydraulic fluid to various subsets of the clutches and brakes.

In order to reduce the fuel consumption of vehicles, some vehicles are configured to turn off the engine when the vehicle is stopped at a light. When the driver releases the brake pedal, the engine is automatically restarted. To satisfy the driver's demand to accelerate, it is important that the engine be restarted and an appropriate transmission ratio be engaged in a very short period of time. In many vehicles, the source of hydraulic pressure to engage the transmission is a pump driven by the engine. Any delay between the engine reaching idle speed and engagement of a suitable transmission ratio contributes to the total delay before vehicle acceleration so this delay must be minimized or eliminated. Some existing vehicles use an electrically driven auxiliary pump to maintain hydraulic pressure while the engine is off. This technique requires significant additional hardware and draws electrical power for the entire period that the engine is stopped with the vehicle in drive. An alternative system, using a hydraulic accumulator to rapidly re-pressurize the clutch engagement hydraulic circuits, has been developed. This accumulator system requires a high flow valve to quickly reengage the clutches in the transmission and a check valve connected to the pump to re-pressurize the accumulator after each use.

### SUMMARY OF THE DISCLOSURE

A pressurized fluid storage system includes a manifold and a reservoir fluidly connected by a passageway. An engine driven pump may supply pressurized fluid to the manifold. The manifold may, in turn, supply pressurized fluid to a hydraulic control system of a vehicle transmission. The reservoir may be, for example, a piston-type accumulator having a piston that slides within a cylinder defining a fluid cavity and a spring that applies force to the piston to maintain pressure in the fluid. A plug within the passageway passively blocks flow when the pressure in the reservoir exceeds the pressure in the manifold and passively permits flow from the manifold to the reservoir whenever the pressure in the manifold exceed the pressure in the reservoir. The plug may be, for example, a check ball that is forced against a seat by pressure in the reservoir and forced away from the seat by pressure in the manifold. An actuator actively forces the plug into a position that permits a high flow rate from the reservoir to the manifold in response to a control signal. The actuator may include a cylinder containing a piston with a protrusion that pushes the plug. Fluid pressure on one side of the piston pushes the piston toward the plug while a spring pushes the piston away from the plug. In one exemplary embodiment, a binary valve controls the fluid pressure pushing the piston towards the plug. In one position of the binary valve, the chamber pushing the piston towards the plug is fluidly connected to the reservoir. In the opposite position of the binary valve, the chamber pushing the piston towards the plug is vented. In another exemplary embodiment, the chamber pushing the piston towards the plug is fluidly connected to the reservoir while the chamber pushing the piston away from the plug is fluidly connected to the manifold. The piston area is set such that these forces nearly balance the forces on the plug, permitting a relatively low force actuator to directly push the piston.

A hydraulic control system includes a single passageway fluidly connecting a reservoir to a manifold, a check valve within the passageway, and an actuator configured to override the check valve in response to a control signal. The system may also include an engine drive pump configured to deliver pressurized fluid to the manifold. The hydraulic control system is useful for rapidly re-engaging transmission clutches as the vehicle engine is restarted, permitting the vehicle to shut the engine off during periods when the vehicle is stationary, such as while waiting at a traffic light. The reservoir is filled while the engine is running by flow past the check valve when pressure in the manifold exceeds pressure in the reservoir. The check valve maintains the reservoir charge when the engine is stopped. As the engine is restarted, the actuator overrides the check valve allowing fluid from the reservoir to rapidly re-engage transmission clutches.

### BRIEF DESCRIPTION OF THE DRAWINGS

FIG. 1 is a schematic representation of a vehicle powertrain.

FIG. 2 is a schematic illustration of a pressurized fluid storage system in a charging configuration.

FIG. 3 is a schematic illustration of a pressurized fluid storage system in a sustaining configuration.

FIG. 4 is a schematic illustration of a pressurized fluid storage system in a discharging configuration.

FIG. 5 is a schematic illustration of a pressurized fluid storage system with an alternative release mechanism.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

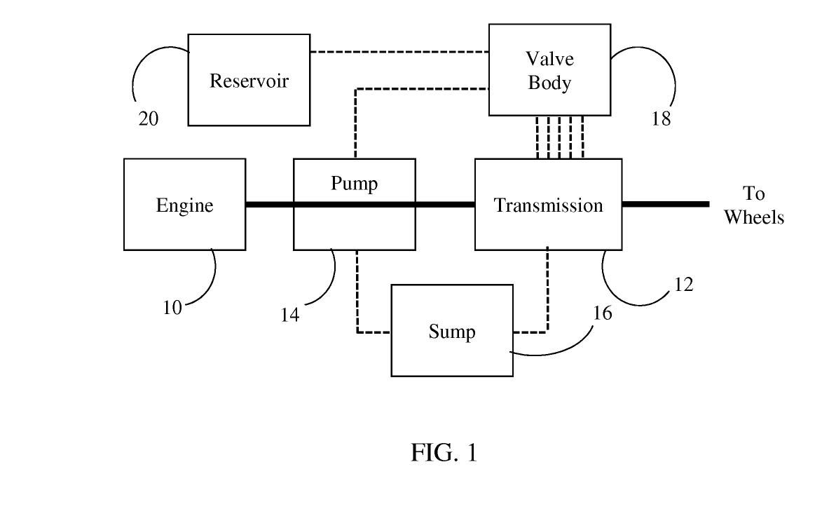

FIG. 1 schematically illustrates a vehicle powertrain. Mechanical power connections are shown as bold solid lines and hydraulic connections are shown as dotted lines. Primary motive power is provided by an internal combustion engine 10. Transmission 12 adapts the speed of the engine to the speed of the driveshaft. Various speed ratios are selected by provided pressurized hydraulic fluid to a subset of the clutches and brakes of transmission 12. Pump 14, which is mechanically driven by the engine, draws fluid from sump 16 and provides fluid at elevated pressure to valve body 18. Valve body 18 routes the pressurized fluid to particular clutches and brakes in transmission 12, perhaps regulating the pressure to a lower pressure than what is provided by pump 14.

Fuel consumption can be reduced by stopping the engine when the vehicle is stationary, such as when waiting at a red light. However, it is important to be able to quickly restart the engine when the driver releases the brake pedal so that the vehicle begins accelerating as soon as the driver depresses the accelerator pedal. When the engine is off, the pump does not provide pressurized fluid to keep the transmission engaged, so the transmission is effectively in neutral. Upon restarting the engine, there is a delay before the pump provides enough pressurized hydraulic fluid to re-engage the transmission clutches. To avoid delay in vehicle acceleration, it is desirable to store pressurized fluid in reservoir 20 while the engine is running and release that fluid to rapidly re-engage the transmission clutches while the engine is being re-started.

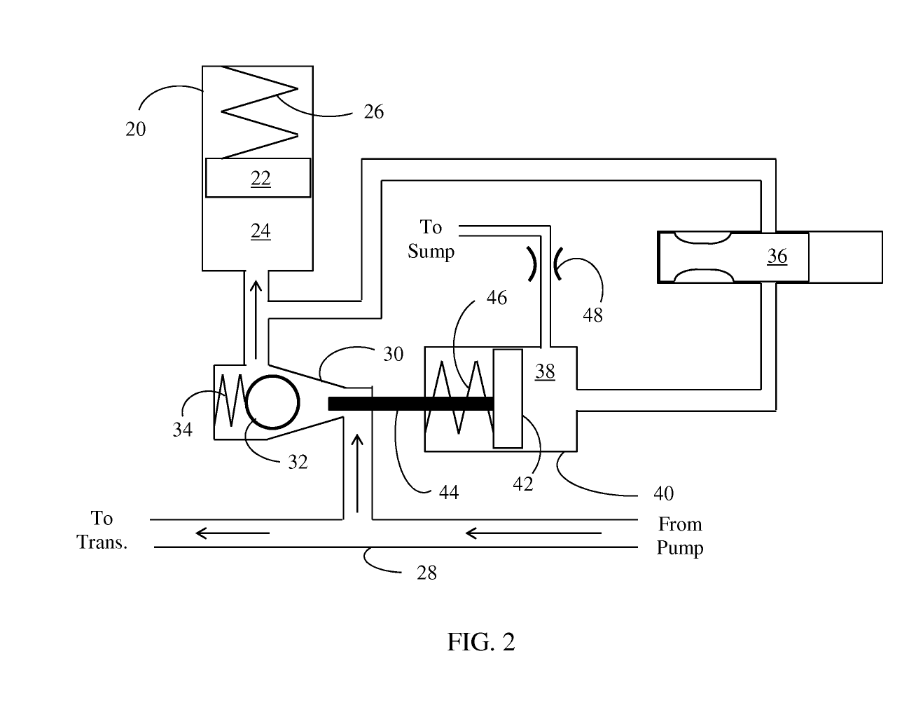

The components of the hydraulic control system that control the flow into and out of reservoir 20 are illustrated in FIGS. 2-4. The reservoir may be, for example, an accumulator with a piston 22 that defines a chamber 24. As fluid flows into the reservoir, piston 22 moves axially to allow the volume of chamber 24 to increase. Spring 26 provides the reaction force to maintain the pressure. Other types of reservoirs, such bladder-type accumulators, may also be suitable.

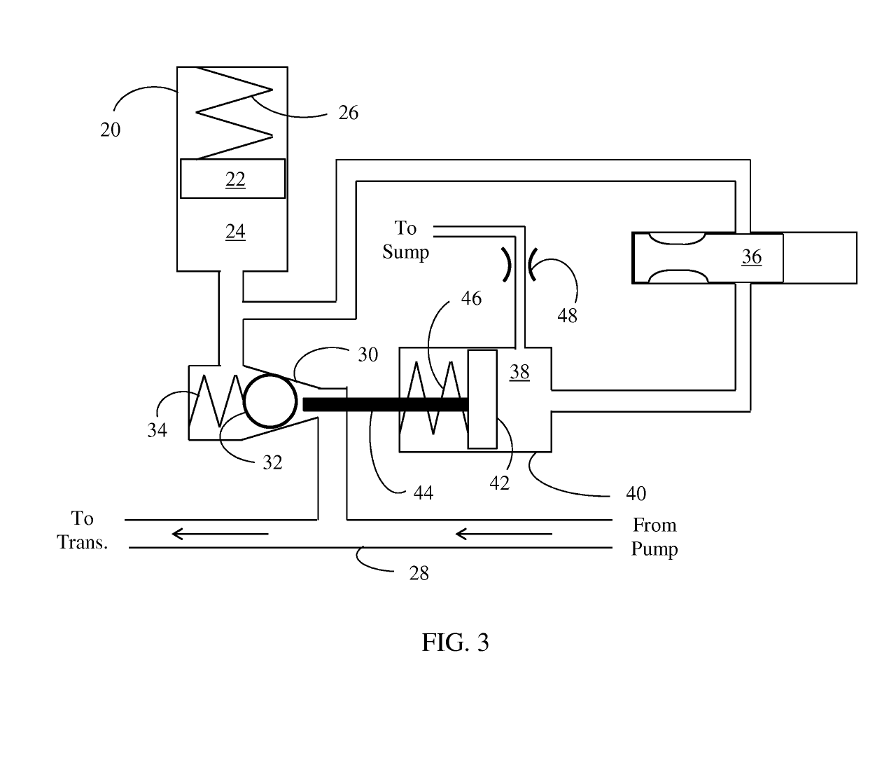

FIG. 2 illustrates the state of the system when the engine is running. The engine driven pump supplies pressurized fluid to a manifold 28 which, in turn, supplies fluid to the transmission clutches through a network of valves. A passageway connects the manifold to the reservoir and includes a check valve. Specifically, the passageway includes a segment containing a ball 32 and a seat 30. Pressure in the reservoir and spring 34 both tend to force ball 32 into the seat preventing flow from the reservoir to the manifold. Spring 34 also acts to control the size of the orifice during charging to limit flow demand, eliminating the need for an orifice and additional check valve. When the pressure in the manifold exceeds the pressure in the reservoir by enough to overcome the spring force, then the ball moves out of the way as shown in FIG. 2 allowing flow from the manifold to the reservoir. Thus, whenever the engine is running, if the pressure in the manifold is greater than the pressure in the reservoir, some of the flow generated by the pump is diverted into the reservoir. When the pressure in the manifold is less than the pressure in the reservoir, the check valve prevents from out of the reservoir as shown in FIG. 3.

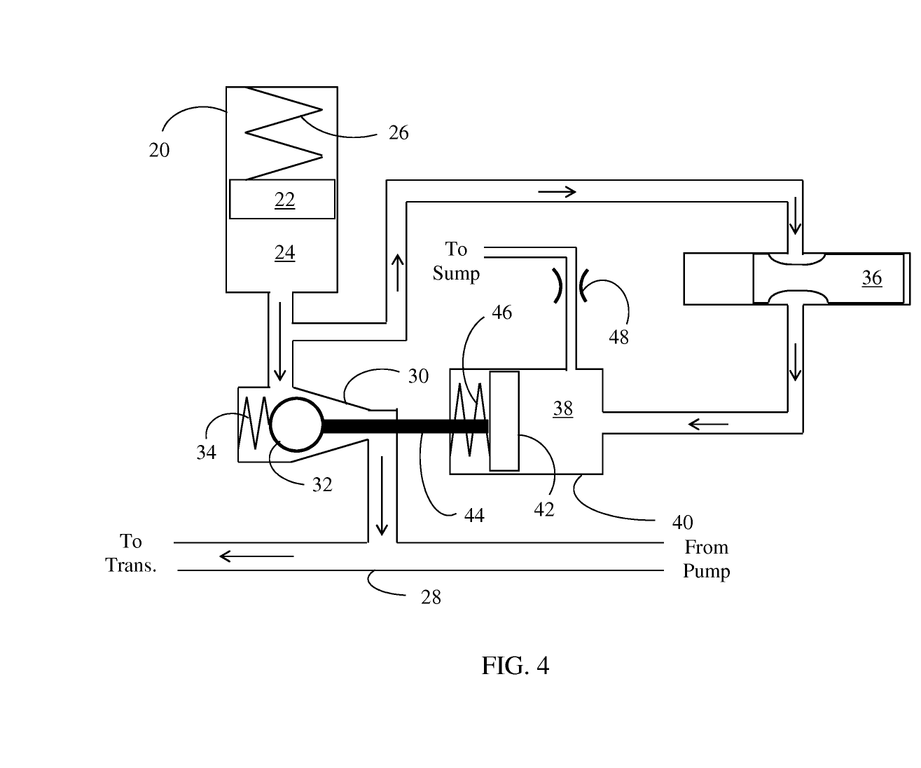

To release the pressurized fluid from the reservoir to engage transmission clutches, the control system moves on/off valve 36 to the open position as shown in FIG. 4. Force to move the on/off valve may be provided by sending electrical current to a solenoid (not shown). Once on/off valve 36 is open, pressurized fluid from the reservoir flows into chamber 38 which is formed by cylinder 40 and piston 42. Rod 44 is fixedly attached to piston 42 and extends into the passageway. As the fluid pushes piston 42 axially, rod 44 pushes ball 32 off the seat 30 allowing fluid to flow freely from the reservoir into the manifold and then on to the transmission clutches.

Once the pump is supplying sufficient fluid, on/off valve 36 is moved to the closed position and the system returns to the state shown in either FIG. 2 or FIG. 3, depending on the relative pressures in the reservoir and the manifold. Return spring 46 pushes piston 42 and rod 44 axially reducing the volume of chamber 38. Fluid in chamber 38 is evacuated to the sump through orifice 48. Orifice 48 is sized to be restrictive enough that leakage is acceptable in the discharge configuration of FIG. 4 and yet large enough that the transition from the discharge configuration to the sustaining configuration of FIG. 3 is acceptably fast.

Prior systems include at least two passageways between the reservoir and the manifold. In these systems, one passageway utilizes a check valve and sometimes an orifice to control flow from the manifold to the reservoir. A second passageway utilizes a high flow valve to control flow from the reservoir to the manifold. This configuration, on the other hand, requires only one passageway between the reservoir 20 and the manifold 28.

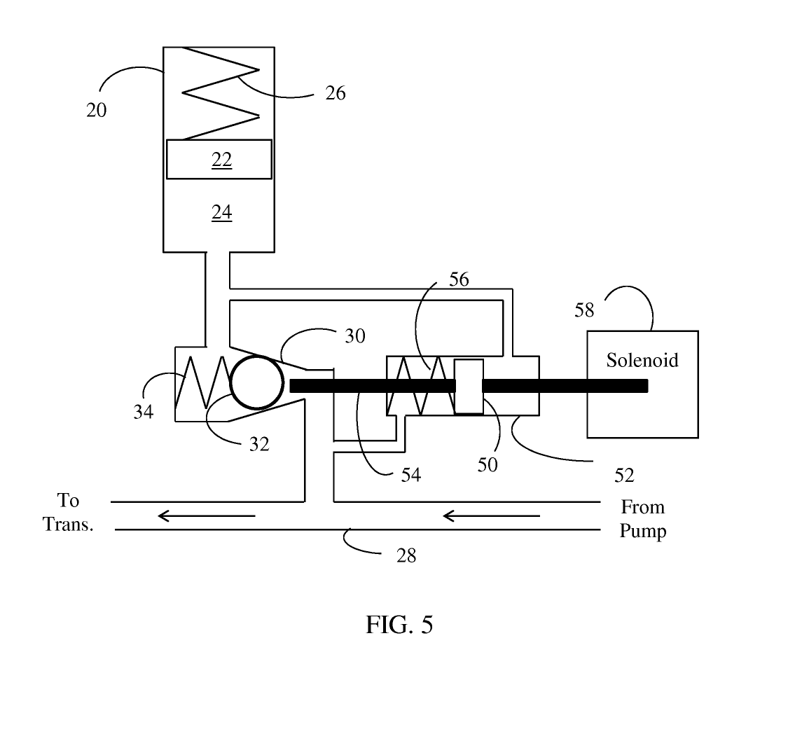

Another embodiment is illustrated in FIG. 5. Piston 50 forms two chambers in cylinder 52. Rod 54 is fixedly attached to piston 50 and extends into the passageway. When the piston moved toward the check valve, rod 54 pushes ball 32 off the seat 30 allowing fluid to flow freely from the reservoir into the manifold and then on to the transmission clutches. Return spring 56 pushes piston 50 away from the check valve. Fluid at the pressure of the reservoir pushes piston 50 towards the check valve while fluid at the pressure of the reservoir pushes piston 50 away from the check valve. Piston 50 has approximately the same area as ball 32 such that the piston balances the hydraulic forces on the ball. As a result, a much lower external force is required to unseat the ball. This force is supplied directly by solenoid 58.

The disclosed system may also be used in other applications that require periodic, relatively short duration supply of pressurized hydraulic fluid. For example, some transfer cases need high pressure and high flow only during a change between low range and high range. With the disclosed system, a small low-flow pump would be able to charge the reservoir between range transitions and the reservoir would provide high flow for the event.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A pressurized fluid storage system comprising:
a manifold in fluid communication with a source of pressurized fluid and in fluid communication with a sink for pressurized fluid;
a reservoir;
a passageway fluidly connecting the reservoir to the manifold;
a plug within the passageway configured to block the passageway in response to a pressure of fluid in the reservoir exceeding a pressure of fluid in the manifold and to passively move into a position that permits flow through the passageway in response to the pressure of fluid in the manifold exceeding the pressure of fluid in the reservoir; and
an actuator configured to move the plug into a position that permits flow through the passageway in response to a control signal.

2. The pressurized fluid storage system of claim 1 wherein the source of pressurized fluid comprises a pump driven by an internal combustion engine.

3. The pressurized fluid storage system of claim 1 wherein the sink for pressurized fluid comprises a hydraulic control system of a vehicle transmission.

4. The pressurized fluid storage system of claim 1 wherein the reservoir comprises:
a cylinder;
a piston configured to slide within the cylinder and defining a chamber, the chamber fluidly connected to the passageway; and
a spring configured to exert force on the piston tending to reduce a volume of the chamber.

5. The pressurized fluid storage system of claim 1 wherein the plug comprises a ball configured to move into a seat in the passageway.

6. The pressurized fluid storage system of claim 5 further comprising a spring configured to passively push the ball into the seat of the passageway.

7. The pressurized fluid storage system of claim 1 wherein the actuator comprises:
a cylinder; and
a piston configured to slide within the cylinder and to define a first chamber within the cylinder, the piston having a protrusion configured to push the plug into a position allowing flow through the passageway when a volume of the chamber exceeds a threshold.

8. The pressurized fluid storage system of claim 7 wherein the actuator further comprises:
a binary valve configured to fluidly connect the first chamber to the reservoir in one state and to separate the first chamber from the reservoir in another state; and
a vent permitting fluid to gradually escape from the first chamber.

9. The pressurized fluid storage system of claim 7 wherein the actuator further comprises a spring configured to exert a force on the piston tending to reduce the volume of the chamber.

10. The pressurized fluid storage system of claim 7 wherein:
the piston defines a second chamber within the cylinder;
the first chamber is fluidly connected to the reservoir; and
the second chamber is fluidly connected to the manifold.

11. A hydraulic control system comprising:
a passageway fluidly connecting a reservoir to a manifold;
a check valve within the passageway configured to block fluid flow in response to a pressure in the reservoir exceeding a pressure in the manifold; and
an actuator configured to override the check valve in response to a control signal, permitting flow through the check valve from the reservoir to the manifold.

12. The hydraulic control system of claim 11 further comprising an engine driven pump configured to draw fluid from a sump and deliver the fluid at an increased pressure to the manifold.

13. The hydraulic control system of claim 11 wherein the actuator comprises:
a cylinder; and
a piston configured to slide within the cylinder and to define a first chamber within the cylinder, the piston having a protrusion configured to override the check valve when a volume of the chamber exceeds a threshold.

14. The hydraulic control system of claim 13 wherein the actuator further comprises:
a binary valve configured to fluidly connect the first chamber to the reservoir in one state and to separate the first chamber from the reservoir in another state; and
a vent permitting fluid to gradually escape from the first chamber.

15. The hydraulic control system of claim 13 wherein the actuator further comprises a spring configured to exert a force on the piston tending to reduce the volume of the first chamber.

16. The hydraulic control system of claim 13 wherein:
the piston defines a second chamber within the cylinder;
the first chamber is fluidly connected to the reservoir; and
the second chamber is fluidly connected to the manifold.
